(19) United States
(12) Patent Application Publication
(10) Pub. No.: US 2007/0245263 A1
(43) Pub. Date: Oct. 18, 2007

(54) GRAPHICAL USER INTERFACE FOR WIRELESS DEVICE

(75) Inventors: Mason Hale, Austin, TX (US); Denise Burton, Austin, TX (US); Bryan Walker, San Marcos, TX (US); Erin Jacobs, Austin, TX (US); Dwayne Stoltz, Austin, TX (US); Mahin Samadini, San Francisco, CA (US); Laura Richardson, Austin, TX (US); Scott Moody, Little Rock, AR (US); Kristi Crum, Maumelle, AR (US)

Correspondence Address: BAKER & MCKENZIE LLP;PATENT DEPARTMENT, 2001 ROSS AVENUE, SUITE 2300, DALLAS, TX, 75201, US

(73) Assignee: ALLTEL COMMUNICATIONS, INC., Little Rock, AR (US)

(21) Appl. No.: 11/610,895

(22) Filed: Dec. 14, 2006

Related U.S. Application Data
(60) Provisional application No. 60/787,132, filed on Mar. 29, 2006.

(51) Int. Cl. G06F 3/048

(52) U.S. Cl. 715/810

(57) ABSTRACT

The present disclosure generally relates to methods and systems for performing a variety of native and non-native tasks with a wireless device employing a user-configurable graphical user interface. In one exemplary embodiment, the graphical user interface can be envisioned as a very wide screen composed of segments, with only one segment of the very wide screen displayed on the wireless device at any given time. The user can view other segments of the very wide screen by using the device keypad to move left and right within the very wide screen. Each segment is composed of one or more independent modular interface components that are associated with tasks, both native and non-native, that can be performed by the wireless device. Related embodiments are also described.

### RELATED APPLICATION

This application claims priority to U.S. provisional patent application No. 60/787,132 filed on Mar. 29, 2006. The disclosure of the above application is incorporated herein by reference in its entirety.

### TECHNICAL FIELD

The present disclosure generally relates to wireless data access and communications and specifically relates to methods for performing native and non-native tasks with a wireless device employing a user-configurable graphical user interface.

### BACKGROUND

As the functionality of wireless devices continues to expand, wireless service providers are constantly searching for ways to conveniently provide content and data services to the wireless device user. Complicating the task is the fact that wireless devices are typically small and therefore have limited screen space on which to display information. The hierarchical nested screens of the typical graphical user interface, though useful and intuitive when displayed on larger screens, can quickly become cumbersome and unmanageable on the smaller screens of typical wireless devices such as mobile phones.

Another issue facing wireless service providers is how to present to the wireless device user both native wireless applications, such as those for initiating a telephone call or sending a text message, and independently developed wireless applications, such as those for accessing web content. The user interface for the typical wireless device segregates independently developed applications from native applications. This segregation can often frustrate the user, who must generally perform several additional keystrokes to access desired content.

A user-configurable graphical user interface is needed that is designed specifically for the smaller screen of the typical wireless device, wherein the wireless device user can quickly and intuitively navigate available content and wherein native and non-native wireless device applications are equally readily accessible.

### BRIEF SUMMARY

One aspect of the disclosed invention is to provide a customizable graphical user interface (the CELLTOP^{SM} environment) for a wireless device, through which the wireless device user can direct the device to perform a variety of tasks. In an exemplary embodiment, this graphical user interface can be envisioned as a very wide screen. At any given time, only one segment of the very wide screen (a CELLTOP^{SM} segment) is displayed on the wireless device. The user can view other segments of the very wide screen by using the device keypad to move left and right within the very wide screen.

Each segment of the very wide screen is composed of one or more independent modular interface components. Each of these independent modular interface components, or Cells, is a mini-application that runs within the CELLTOP^{SM} environment. Cells provide simple functionality and targeted access to content and data services. In an exemplary embodiment, a CELLTOP^{SM} environment is provided in which a number of user-configurable CELLTOP^{SM} segments are available, and in which the user can place, for example, an Inbox Cell that allows the user to view, reply to, and create SMS messages, a Call Log Cell that allows the user to view and reply to recent calls, and an NFL Sports Cell that allows the user to access score reports and other data from National Football League games through a wireless connection to the Internet.

### BRIEF DESCRIPTION OF THE DRAWINGS

FIG. 1 is a representative illustration of the concept of a very wide screen for a wireless device.

FIG. 2 is a representative illustration of how a very wide screen can be displayed on a wireless device.

FIG. 3 illustrates one embodiment of a visual display template comprising a single zone.

FIG. 4 illustrates one embodiment of a visual display template comprising two zones.

FIG. 5 illustrates one embodiment of a visual display template comprising four zones.

FIG. 6 illustrates one embodiment of a visual display template comprising three zones.

FIG. 7 illustrates one embodiment of a graphical user interface for displaying a very wide screen on a wireless device.

FIG. 8 illustrates one embodiment of a graphical user interface for modifying the configuration of independent modular interface components in a very wide screen displayed on a wireless device.

FIG. 9 illustrates one embodiment of a graphical user interface for adding an independent modular interface component to the very wide screen displayed on a wireless device.

FIG. 10 illustrates one embodiment of a graphical user interface for removing an independent modular interface component from the very wide screen displayed on a wireless device.

FIG. 11 illustrates one embodiment of a graphical user interface for modifying the background theme of the graphical user interface displayed on a wireless device.

FIG. 12 is a process flow diagram depicting a representative process for performing a task with a wireless device employing a graphical user interface.

FIG. 13 is a diagram illustrating a representative memory, processor, input, and output configuration suitable for performing a task with a wireless device employing a graphical user interface. FIG. 13A illustrates the components as built into a wireless device. FIG. 13B is a block diagram of the system.

### DETAILED DESCRIPTION

Various aspects of a method and system for performing tasks with a wireless device employing a graphical user interface according to the present disclosure are described. It is to be understood, however, that the following explanation is merely exemplary in describing aspects of the present disclosure. Accordingly, several modifications, changes, and substitutions are contemplated.

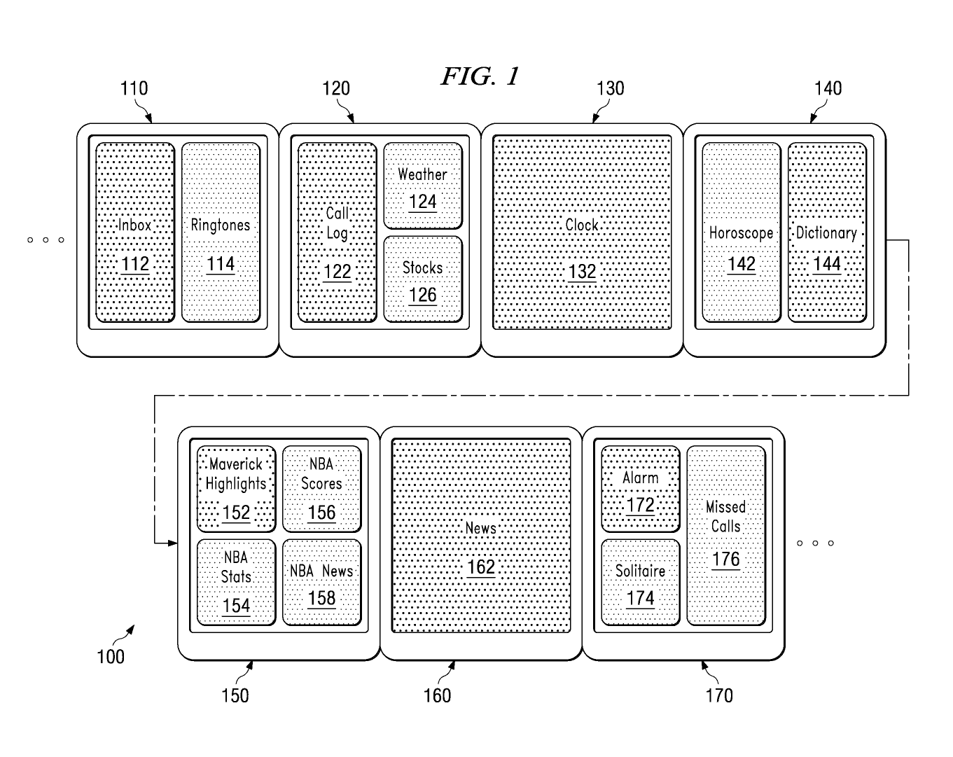

One aspect of the disclosed invention is to provide a customizable graphical user interface (the CELLTOP^{SM} environment) for a wireless device, through which the wireless device user can direct the device to perform a variety of tasks. In an exemplary embodiment, one aspect of this graphical user interface can be envisioned as very wide screen 100, as shown in FIG. 1. In this embodiment, very wide screen 100 is an ordered series of linearly arranged visual display segments 110, 120, 130, 140, 150, 160, and 170. Each of these visual display segments will be referred to as a CELLTOP^{SM} segment for purposes of this specification. Very wide screen 100 can be composed of a single visual display segment or can be composed of multiple visual display segments. At any given time, only one segment of the very wide screen is displayed on the wireless device. The user can view other segments of the very wide screen by navigating horizontally, i.e., left and right, within the very wide screen, for example by using the device keypad. Alternatively, this aspect of the graphical user interface can be envisioned as a very tall screen comprising an ordered series of linearly arranged visual display segments. In this embodiment, the user can view other segments of the very tall screen by navigating vertically, i.e., up and down, for example by using the device keypad.

Each visual display segment, or CELLTOP^{SM} segment, of the very wide screen is composed of one or more independent modular interface components. These independent modular interface components will be referred to as Cells for purposes of this specification. In the exemplary embodiment of FIG. 1, CELLTOP^{SM} segment 120 is composed of Cells 122, 124, and 126, while CELLTOP^{SM} segment 160 is composed of Cell 162. Each Cell is associated with a task that can be performed by the wireless device. A Cell can be associated with a task that can be performed through an application native to the wireless device, or a Cell can be associated with a task that can be performed through an application developed for execution on a device-independent software platform. Examples of tasks that can be performed through applications native to the wireless device are initiating a telephone call or sending a text message. An example of a task that can be performed through an application developed for execution on a device-independent software platform is retrieving and providing electronic information from the World Wide Web using an application developed for QUALCOMM's Binary Runtime Environment for Wireless™ (BREW™). These examples are not exclusive and many other native and non-native tasks are contemplated, including applications developed for other device-independent software platforms.

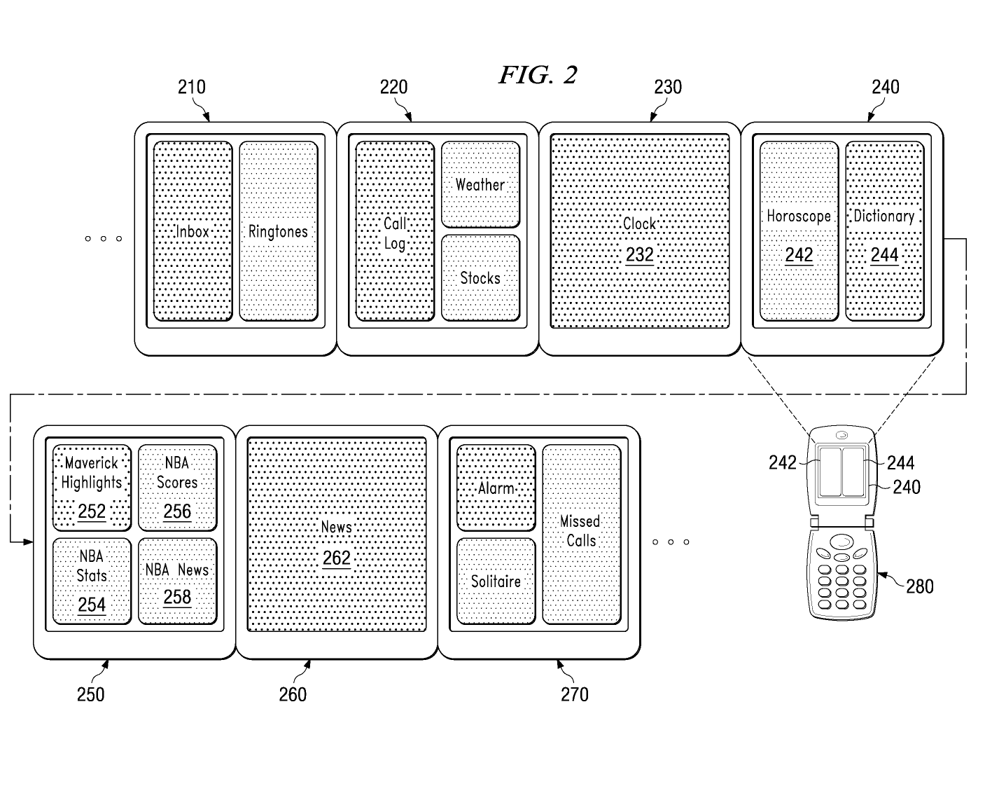

FIG. 2 is a representative illustration of how a very wide screen can be displayed on a wireless device. In this example, CELLTOP^{SM} segment 240 is currently displayed on wireless device 280. CELLTOP^{SM} segment 240 is comprised of Horoscope Cell 242 and Dictionary Cell 244. If the user of wireless device 280 desires to direct the wireless device to perform the task associated with Dictionary Cell 244, for example, to retrieve from an external database the definition of the word “synergy,” the user can use the keypad or other input device to highlight Dictionary Cell 244 and further use the keypad or other input device to invoke performance of the task associated with highlighted Dictionary Cell 244. If the user of wireless device 280 desires to direct the wireless device to perform the task associated with Horoscope Cell 242, for example, to retrieve today's horoscope for zodiac sign Libra, the user can use the keypad or other input device to highlight Horoscope Cell 242 and further use the keypad or other input device to invoke performance of the task associated with highlighted Horoscope Cell 242.

If the user desires to direct the wireless device to perform a task other than those tasks associated with Horoscope Cell 242 or Dictionary Cell 244, the user can use the keypad or other input device to transition to another CELLTOP^{SM} segment. In an exemplary embodiment, the user can press the left arrow on the navigation keypad of the wireless device to effect the transition. In an alternative embodiment, the user can press the up arrow on the navigation keypad of the wireless device to navigate within a very tall screen embodiment. In the representative very wide screen embodiment of FIG. 2, pressing the left arrow causes CELLTOP^{SM} segment 230 and its associated Clock Cell 232 to be displayed. Had the user pressed the right arrow instead, then CELLTOP^{SM} segment 250 and its associated Mavericks Highlights Cell 252, NBA Stats Cell 254, NBA Scores Cell 256, and NBA News Cell 258 would be displayed. In this manner, the user can transition to any CELLTOP^{SM} segment in the very wide screen. In some embodiments, the CELLTOP^{SM} segments in the very wide screen are configured as a loop, and continued horizontal navigation to the right or left will result in eventually returning to the starting CELLTOP^{SM} segment. In other embodiments, the CELLTOP^{SM} segments in the very wide screen are configured with a first CELLTOP^{SM} segment and a last CELLTOP^{SM} segment. In these embodiments, continued horizontal navigation to the right will result in the eventual display of the last CELLTOP^{SM} segment, while continued horizontal navigation to the left will result in the eventual display of the first CELLTOP^{SM} segment. Alternative embodiments contemplate similar functionality within very tall screen embodiments, wherein continued vertical navigation up and down in some embodiments will result in returning to the starting CELLTOP^{SM} segment, while continued vertical navigation up and down in other embodiments will result in eventual display of the first or last CELLTOP^{SM} segment. Furthermore, some embodiments may specifically label individual CELLTOP^{SM} segments as, for example, CELLTOP^{SM} segment 1, CELLTOP^{SM} segment 2, CELLTOP^{SM} segment 3, etc. In these embodiments, the user can transition to a specific CELLTOP^{SM} segment by indicating through the wireless device keypad or other input device which CELLTOP^{SM} segment to display.

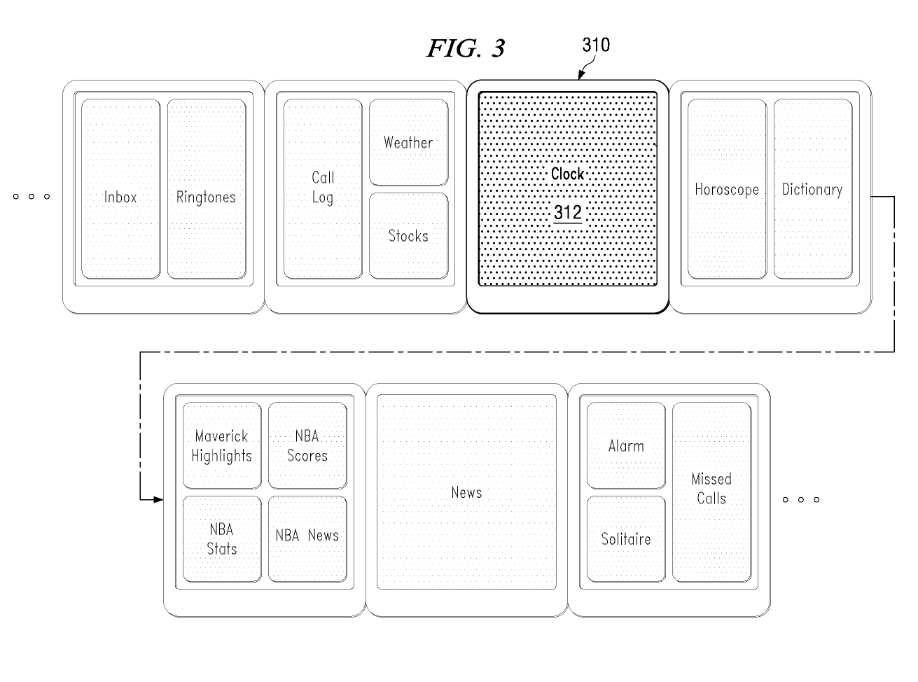

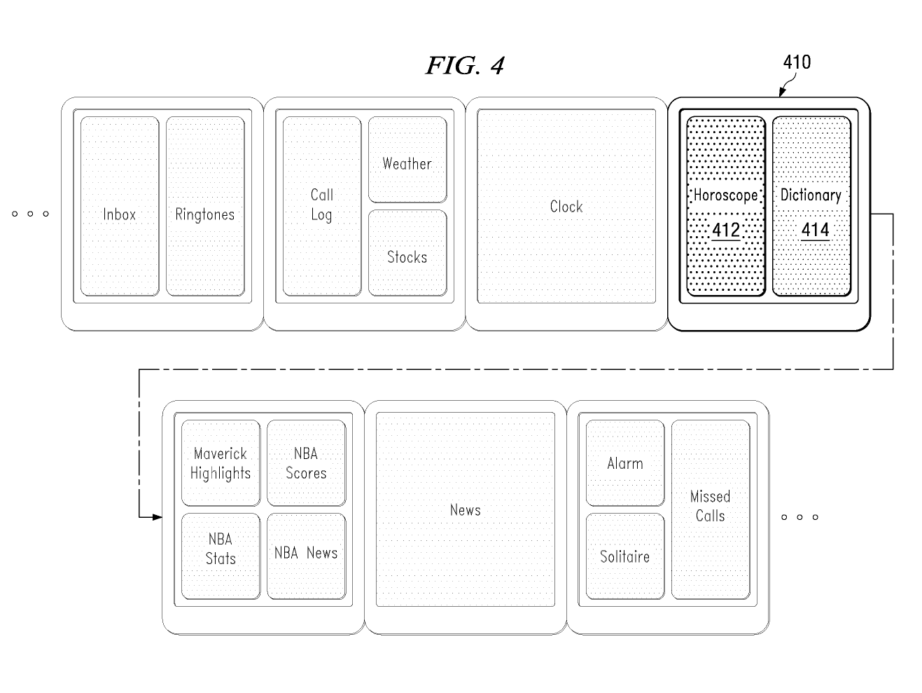

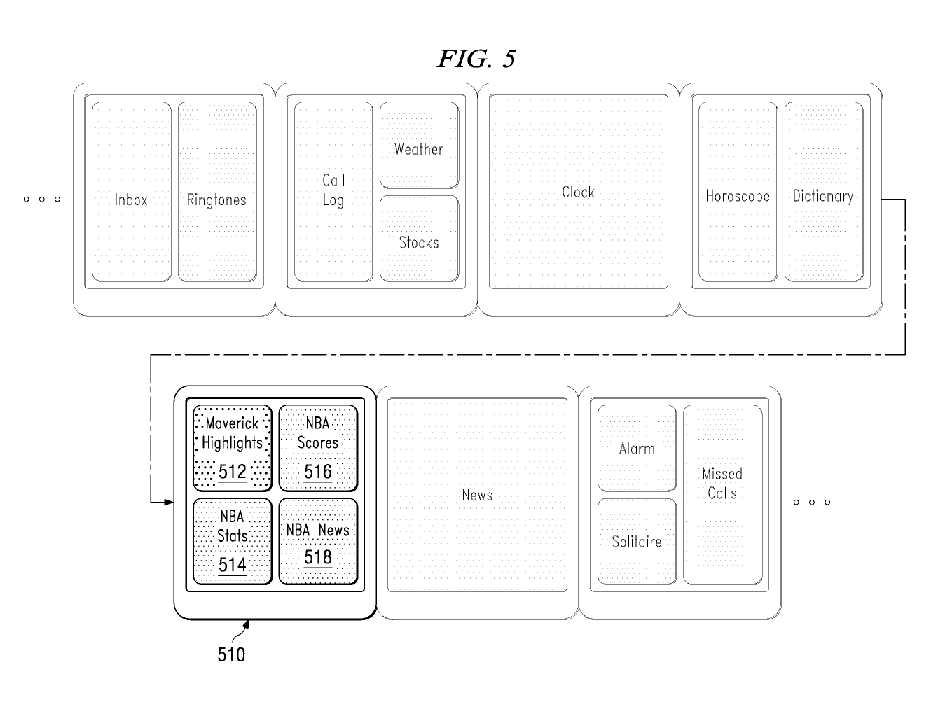

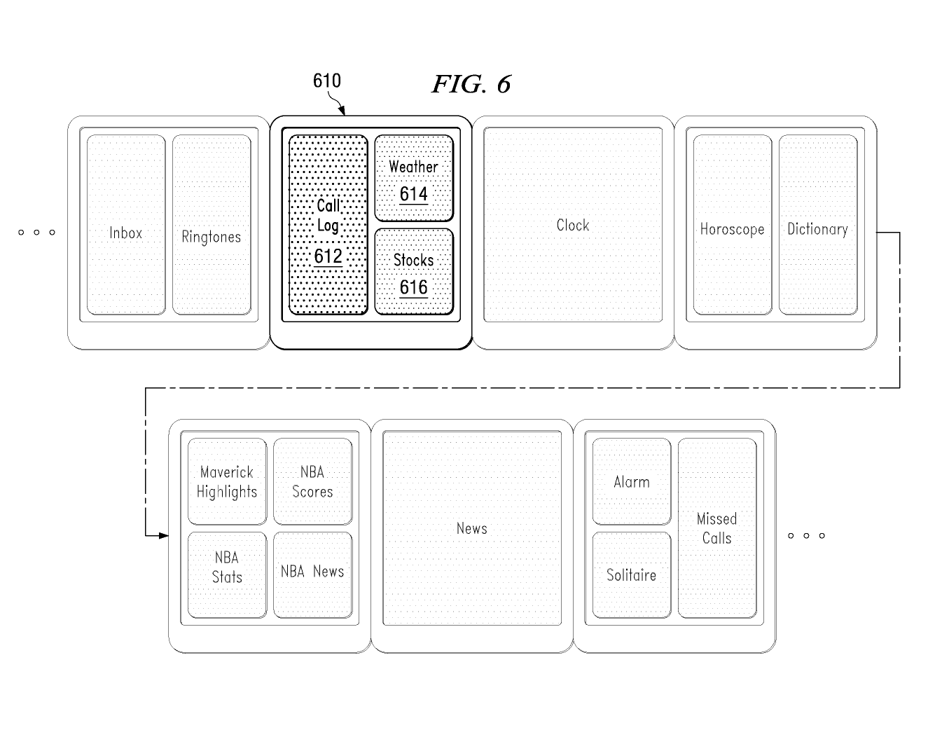

The arrangement of Cells on a CELLTOP^{SM} segment displayed on a wireless device is defined by any of a number of visual display templates. FIG. 3, FIG. 4, FIG. 5, and FIG. 6 illustrate representative embodiments of possible arrangements of Cells on a CELLTOP^{SM} segment. The visual display templates described in these figures are representative examples only and other visual display templates are contemplated.

FIG. 3 illustrates one embodiment of a visual display template comprising a single zone. In this embodiment, the single zone encompasses substantially all of the visual display area. As shown in FIG. 3, CELLTOP^{SM} segment 310 is composed of single Cell 312. When CELLTOP^{SM} segment 310 is displayed on a wireless device, a user desiring to invoke a task can direct the wireless device to perform only the task associated with Cell 312. If the user desires to invoke performance of a different task, a transition to another CELLTOP^{SM} segment is required.

FIG. 4 illustrates one embodiment of a visual display template comprising two zones. In this embodiment, each of the two zones encompasses substantially one-half of the visual display area. As shown in FIG. 4, CELLTOP^{SM} segment 410 is composed of Cell 412 and Cell 414. When CELLTOP^{SM} segment 410 is displayed on a wireless device, a user desiring to invoke a task can direct the wireless device to perform either the task associated with Cell 412 or the task associated with Cell 414. If the user desires to invoke performance of a different task, a transition to another CELLTOP^{SM} segment is required.

FIG. 5 illustrates one embodiment of a visual display template comprising four zones. In this embodiment, each of the four zones encompasses substantially one-fourth of the visual display area. As shown in FIG. 5, CELLTOP^{SM} segment 510 is composed of Cell 512, Cell 514, Cell 516, and Cell 518. When CELLTOP^{SM} segment 510 is displayed on a wireless device, a user desiring to invoke a task can direct the wireless device to perform any of the tasks associated with Cells 512, 514, 516, or 518. If the user desires to invoke performance of a different task, a transition to another CELLTOP^{SM} segment is required.

FIG. 6 illustrates one embodiment of a visual display template comprising three zones. In this embodiment, one of the three zones encompasses substantially one-half of the visual display area, and two of the three zones encompasses substantially one-fourth of the visual display area. As shown in FIG. 6, CELLTOP^{SM} segment 610 is composed of Cell 612, Cell 614, and Cell 616. When CELLTOP^{SM} segment 610 is displayed on a wireless device, a user desiring to invoke a task can direct the wireless device to perform any of the tasks associated with Cells 612, 614, or 616. If the user desires to invoke performance of a different task, a transition to another CELLTOP^{SM} segment is required.

In a preferred embodiment, when a CELLTOP^{SM} segment is displayed on a wireless device, exactly one Cell on the CELLTOP^{SM} segment is highlighted. A highlighted Cell is distinguished from other Cells on the same CELLTOP^{SM} segment in that the highlighted Cell is bolder, brighter, larger, outlined, shaded differently, colored differently, or otherwise distinguished from the other Cells on the CELLTOP^{SM} segment. In this preferred embodiment, a Cell must be highlighted before its associated task can be performed. If the user desires to invoke performance of the task associated with the highlighted Cell, then the user indicates to the device that performance is desired. The user accomplishes this by using the device keypad or other input device, for example, by pressing a particular key on the device keypad. However, other embodiments contemplate other input devices, such as a microphone together with voice recognition software or a touch-sensitive screen with a stylus. If the user desires to invoke performance of a task associated with a Cell displayed on the CELLTOP^{SM} segment other than the highlighted Cell, then the user must first select the desired Cell, thus highlighting it, before invoking performance. The user accomplishes selection of the desired Cell by using the device keypad or other input device to navigate to the desired Cell. In an exemplary embodiment, the user can use the device keypad navigation arrows to move up, down, left, and right with the displayed CELLTOP^{SM} segment until the desired Cell is highlighted.

Each Cell represents an independent modular interface component of a graphical user interface for a wireless device. In an exemplary embodiment, the graphical user interface is divided into visual display segments, or CELLTOP^{SM} segments, and Cells are grouped together in these CELLTOP^{SM} segments according to visual display templates. Any Cell can inhabit any location on any CELLTOP^{SM} segment where the templates allow Cells to be placed. In a preferred embodiment, the wireless device is distributed with one or more Cells preloaded on the CELLTOP^{SM} segment, additional Cells stored in a repository on the wireless device, and still other Cells available for downloading to the wireless device. These options allow a user to configure the wireless device to display only the Cells in which the user is interested.

Each Cell is associated with a task executable by the wireless device. A Cell can be associated with native wireless device applications or non-native wireless device applications. Representative examples of Cells associated with native wireless device applications are (1) an Inbox Cell that allows the user to view, reply to, and create SMS messages; (2) a Call Log Cell that allows the user to view and reply to recent calls and provides quick access to voicemail; and (3) a Ringtones Cell that allows the user to change the user's current ringtone and also allows the user to view and purchase ringtones. Representative examples of Cells associated with non-native wireless device applications are (1) a Weather Cell that allows the user to view weather for user-selected cities; (2) an NFL Sports Cell that allows the user to see National Football League Games for the current day or week; (3) a Stocks Cell that allows the user to track changes in the prices of user-selected stocks; (4) a News Cell that allows users to view news from the Associated Press, and (5) a Clock Cell that shows the current time in a user-selected time zone. These examples are representative only and other types of native and non-native Cells are contemplated.

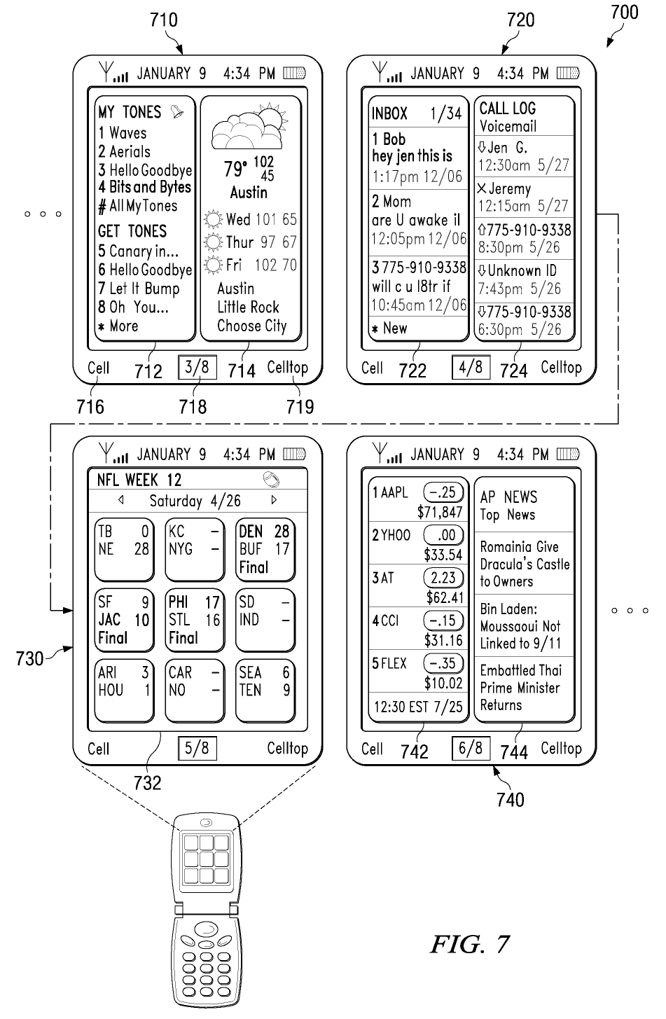

Although Cells are important components of the disclosed graphical user interface, preferred embodiments include additional features. As shown in FIG. 7, the graphical user interface is composed of more than just the CELLTOP^{SM} segment and its associated Cells. The graphical user interface can contain a variety of additional features, such as the current date, the current time, a signal strength indicator, and a battery life indicator. In a preferred embodiment, CELLTOP^{SM} counter 718 is displayed. In the representative example of FIG. 7, eight CELLTOP^{SM} segments are available in the current configuration of the graphical user interface; the third, fourth, fifth, and sixth are shown. The currently displayed CELLTOP^{SM} segment 730 is the fifth of the eight available CELLTOP^{SM} segments, as indicated by the “5/8” displayed by the CELLTOP^{SM} counter. Should the user navigate left to display CELLTOP^{SM} segment 720, the CELLTOP^{SM} counter will automatically update to display “4/8.” Should the user navigate right to display CELLTOP^{SM} segment 740, the CELLTOP^{SM} counter will automatically update to display “6/8.” As the user continues to navigate between CELLTOP^{SM} segments, CELLTOP^{SM} counter 718 is automatically updated to reflect the particular CELLTOP^{SM} segment currently displayed. In the preferred embodiment represented by FIG. 7, CELLTOP^{SM} counter 718 is shown as a fraction with the numerator representing the currently displayed CELLTOP^{SM} segment and the denominator representing the total number of CELLTOP^{SM} segments available. In another embodiment, CELLTOP^{SM} counter 718 is shown as a series of numbers representing all available CELLTOP^{SM} segment with the currently displayed CELLTOP^{SM} segment number highlighted or otherwise distinguished. Other formats for CELLTOP^{SM} counter 718 are also contemplated.

Additional components of the graphical user interface contemplated by the preferred embodiment are Cell Menu Indicator 716 and CELLTOP^{SM} Menu Indicator 719. In a representative embodiment, the Cell Menu is invoked by pressing the left soft key on the wireless device, while the CELLTOP^{SM} Menu is invoked by pressing the right soft key on the wireless device. Invoking the Cell Menu or CELLTOP^{SM} Menu results in the display of menu selection items that “pop up” on the display screen and allow the user to choose from a variety of configuration options. In a preferred embodiment, invoking the CELLTOP^{SM} Menu results in the display of the same menu options regardless of which CELLTOP^{SM} segment is currently displayed, while invoking the Cell Menu results in the display of menu options that are tailored to the highlighted Cell. For example, if CELLTOP^{SM} segment 710 is the currently displayed CELLTOP^{SM} segment, and Ringtones Cell 712 is the currently highlighted Cell, then invoking the CELLTOP^{SM} Menu results in the display of a generic menu containing menu items such as “Add Cell,” while invoking the Cell Menu results in the display of a menu that is tailored to Ringtones Cell 712. In a preferred embodiment, the pop up menu associated with Ringtones Cell 712 would contain menu items such as “Add Ringtone” and “Set Ringtone” in addition to menu items available in all Cell Menus, such as “Move Cell” and “Remove Cell.” Alternatively, if CELLTOP^{SM} segment 710 is the currently displayed CELLTOP^{SM} segment, and Weather Cell 714 is the currently highlighted Cell, then invoking the CELLTOP^{SM} Menu results in the display of the same generic menu containing menu items such as “Add Cell,” while invoking the Cell Menu results in the display of a menu that is tailored to Weather Cell 714. In a preferred embodiment, the pop up menu associated with Weather Cell 714 would contain menu items such as “Choose City” or “Manage City” in addition to the menu items available in all Cell Menus, such as “Move Cell” and “Remove Cell.”

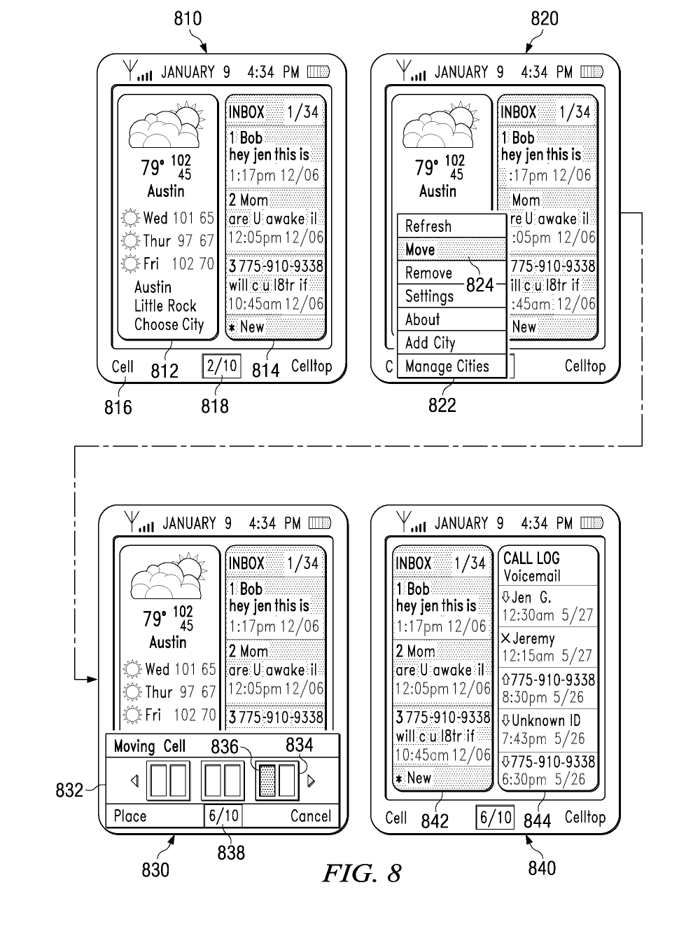

Preferred embodiments of the disclosed invention provide for user-configurability of the graphical user interface. FIG. 8 illustrates one embodiment of a graphical user interface for modifying the configuration of Cells on a CELLTOP^{SM} segment as displayed on a wireless device. In a representative example, CELLTOP^{SM} segment 810 is currently displayed on the wireless device. CELLTOP^{SM} segment 810 is the second of ten CELLTOP^{SM} segments in the very wide screen, as shown by CELLTOP^{SM} Counter 818. CELLTOP^{SM} segment 810 is composed of two cells, Weather Cell 812 and Inbox Cell 814. If the user desires to reconfigure the CELLTOP^{SM} environment to place the Inbox Cell on the sixth CELLTOP^{SM} segment 840, the user can accomplish this by invoking Cell Menu 822, the availability of which is determined by the presence of Cell Menu Indicator 816. In a preferred embodiment, the user invokes Cell Menu 822 by pressing the left soft key on the wireless device. Cell Menu 822 then “pops up” on the display screen and offers the user a variety of configuration options, including Move menu item 824. The user then selects the Move menu item, preferably by pressing the arrows on the navigation keypad until the Move menu item is highlighted, and then directs the wireless device to perform the Move operation, preferably by pressing “OK” or “Enter” on the device keypad. Once the Move menu item is selected and invoked, Move Task Panel 832 slides up from the bottom of the display screen. Move Task Panel 832 displays a graphical representation of a subset of the very wide screen. In a preferred embodiment, up to three CELLTOP^{SM} segments from the very wide screen are graphically represented at any one time in Move Task Panel 832; however, other embodiments are contemplated. Once Move Task Panel 832 is displayed, the user navigates within Move Task Panel 832 to target Cell 836 of target CELLTOP^{SM} segment 834 where the Inbox Cell will be moved. Once target Cell 836 of target CELLTOP^{SM} segment 834 is highlighted, the user directs the wireless device to reconfigure the graphical user interface with Inbox Cell 842 on the sixth CELLTOP^{SM} segment 840, preferably by using the left soft key to indicate that placement is desired. Pressing the right soft key at this point preferably results in cancellation of the Move and the disappearance of Move Task Panel 832 from the display screen.

In a preferred embodiment, all Cells between original Inbox Cell location 814 and target Inbox Cell location 842, including the Cell currently located in the target location, will shift to the left in order to complete the move of the Inbox Cell. In an alternative embodiment, the Cell currently located in the target location and all Cells to the right of the target location will shift to the right to accommodate the moved Cell, leaving Weather Cell 812 as the lone Cell on the second CELLTOP^{SM} segment. In yet another embodiment, the user is prompted to determine how affected Cells should be reconfigured to accommodate the moved Cell.

The particular subset of the very wide screen displayed in Move Task Panel 832 can be modified by the user if necessary to complete the desired move. For example, in FIG. 8, Inbox Cell 814 on the second CELLTOP^{SM} segment 810 is highlighted prior to invocation of Move Task Panel 832. In a preferred embodiment, when Move Task Panel 832 is invoked, the subset of the very wide screen represented includes the second CELLTOP^{SM} segment 810 where the targeted Cell currently resides along with the adjacent first and third CELLTOP^{SM} segments. In order to complete the move of the Inbox Cell to sixth CELLTOP^{SM} segment 840, the displayed subset of the very wide screen must first be modified to include the sixth CELLTOP^{SM} segment. In a preferred embodiment, the user can indicate that a shift in the subset represented is desired by continued use of the left and right navigation keys after reaching the leftmost or rightmost cell represented on Move Task Panel 832. In the representative example shown in FIG. 8, the user repeatedly presses the right navigation key until CELLTOP^{SM} Counter 838 indicates that the sixth CELLTOP^{SM} segment is displayed. The user may then proceed to highlight target Cell 836 of target CELLTOP^{SM} segment 834 as displayed by Move Task Panel 832, and complete the move.

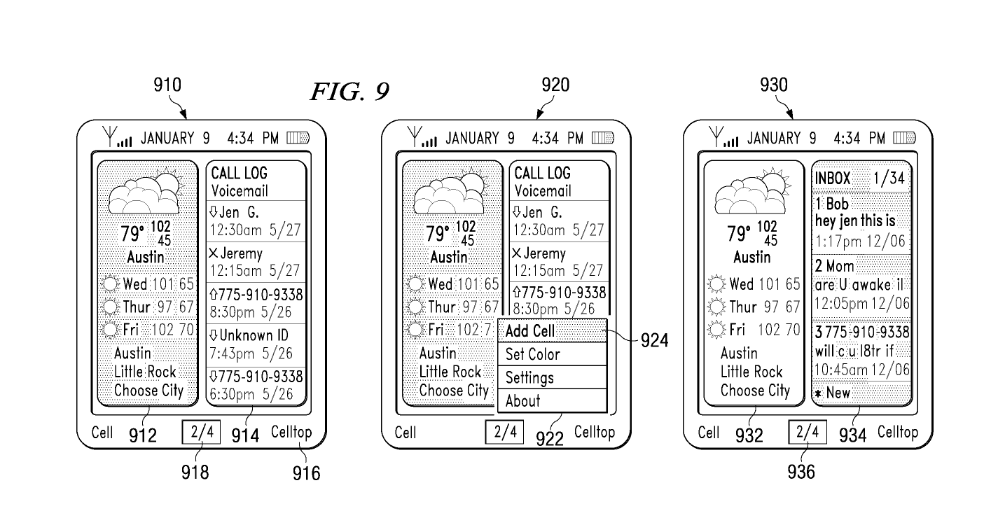

In addition to moving Cells, preferred embodiments of the disclosed invention allow the user to add a Cell to a CELLTOP^{SM} segment in the very wide screen. FIG. 9 illustrates one embodiment of a graphical user interface for adding a Cell. In a representative example, CELLTOP^{SM} segment 910 is currently displayed on the wireless device. CELLTOP^{SM} segment 910 is the second of four CELLTOP^{SM} segments in the very wide screen, as shown by CELLTOP^{SM} Counter 918. CELLTOP^{SM} segment 910 is composed of two cells, Weather Cell 912 and Call Log Cell 914. Weather Cell 912 is currently highlighted. If the user desires to reconfigure the CELLTOP^{SM} environment to add an Inbox Cell to CELLTOP^{SM} segment 910, the user can accomplish this by invoking CELLTOP^{SM} Menu 922, the availability of which is determined by the presence of CELLTOP^{SM} Menu Indicator 916. In a preferred embodiment, the user invokes CELLTOP^{SM} Menu 922 by pressing the right soft key on the wireless device. CELLTOP^{SM} Menu 922 then “pops up” on the display screen and offers the user a variety of configuration options, including Add Cell menu item 924. The user then selects the Add Cell menu item, preferably by pressing the arrows on the navigation keypad until the Add Cell menu item is highlighted, and then directs the wireless device to perform the Add Cell operation, preferably by pressing “OK” or “Enter” on the device keypad.

In a preferred embodiment, once the Add Cell menu item is selected and invoked, the user is presented with an Add Cell screen. On the Add Cell screen, the user is prompted to select a Cell for addition to the CELLTOP^{SM} environment. Cells can be selected, for example, from those Cells stored in a repository on the wireless device, or Cells can be downloaded from sources external to the wireless device. Returning to the representative example shown in FIG. 9, after the user has selected the Inbox Cell for addition to the CELLTOP^{SM} environment, Inbox Cell 934 now appears on the second CELLTOP^{SM} segment 930. In a preferred embodiment, the Cell selected for addition to the CELLTOP^{SM} environment is placed to the right of the highlighted Cell. The Cell currently located to the right of the highlighted Cell (Call Log Cell 914 in this example) and all Cells further to the right will shift to the right to accommodate the added Cell. In an alternative embodiment, the user is prompted to determine how affected Cells should be reconfigured to accommodate the added Cell.

The preferred embodiment of the disclosed invention includes an alternate procedure for invoking the Add Cell screen. In this embodiment, a unique Cell is available, the “Add Cell” Cell. The “Add Cell” Cell is permanently located on one of the available CELLTOP^{SM} segments; in alternative embodiments, the “Add Cell” Cell may be invoked by the user. Highlighting the “Add Cell” Cell results in the appearance of the Add Cell screen to allow the user to select a Cell to be added.

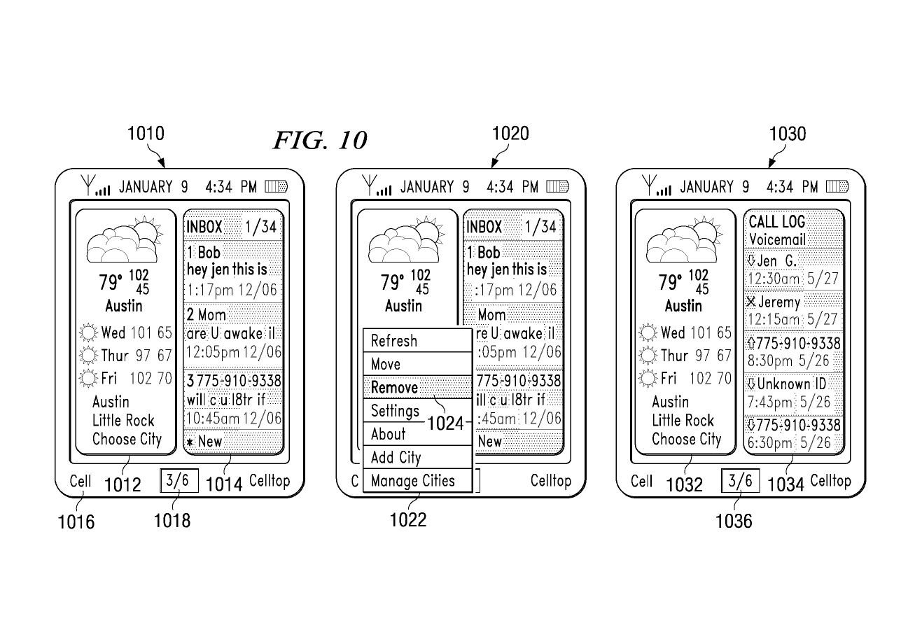

In addition to adding and moving Cells, preferred embodiments of the disclosed invention allow the user to remove a Cell from a CELLTOP^{SM} segment in the very wide screen. FIG. 10 illustrates one embodiment of a graphical user interface for removing a Cell. In a representative example, CELLTOP^{SM} segment 1010 is currently displayed on the wireless device. CELLTOP^{SM} segment 1010 is the third of six CELLTOP^{SM} segments in the very wide screen, as shown by CELLTOP^{SM} Counter 1018. CELLTOP^{SM} segment 1010 is comprised of two cells, Weather Cell 1012 and Inbox Cell 1014. Inbox Cell 1014 is currently highlighted. If the user desires to reconfigure the CELLTOP^{SM} environment to remove highlighted Inbox Cell 1014 from the CELLTOP^{SM} environment, the user can accomplish this by invoking Cell Menu 1022, the availability of which is determined by the presence of Cell Menu Indicator 1016. In a preferred embodiment, the user invokes Cell Menu 1022 by pressing the left soft key on the wireless device. Cell Menu 1022 then “pops up” on the display screen and offers the user a variety of configuration options, including Remove menu item 1024. The user then selects the Remove menu item, preferably by pressing the arrows on the navigation keypad until the Remove menu item is highlighted, and then directs the wireless device to perform the Remove operation, preferably by pressing “OK” or “Enter” on the device keypad. Inbox Cell 1014 is then removed from the CELLTOP^{SM} environment.

In a preferred embodiment, the Cell currently located to the right of the highlighted Inbox Cell 1014 targeted for removal (Call Log Cell 1034 in this example) and all Cells further to the right will shift to the left and fill the void left by removed Inbox Cell 1014. In an alternative embodiment, the user is prompted to determine how Cells should be reconfigured after the Cell is removed.

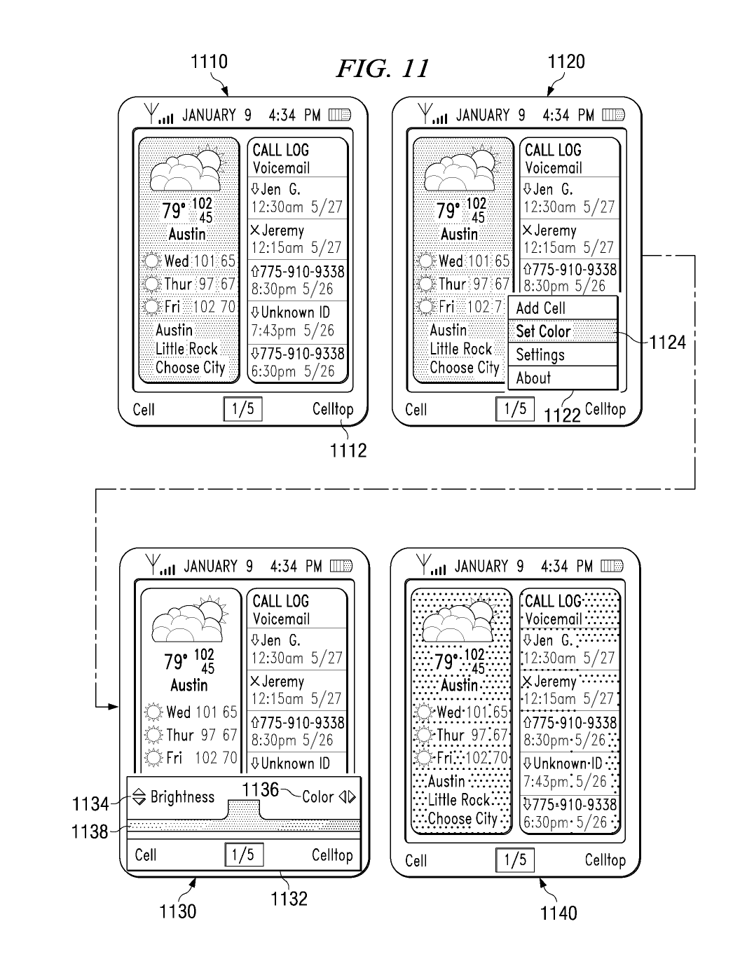

Preferred embodiments of the disclosed invention provide for a background theme for the graphical user interface. The background theme provides an added level of user-configurability of the graphical user interface by allowing the user to choose an overall stylistic environment for the graphical user interface. In the preferred embodiment, the user can configure the background theme of the graphical user interface by choosing a color and brightness level. FIG. 11 illustrates this embodiment of a graphical user interface for modifying the background color and brightness level of the graphical user interface displayed on a wireless device.

In a representative example, CELLTOP^{SM} segment 1110 is currently displayed on the wireless device. If the user desires to reconfigure the CELLTOP^{SM} environment to modify the background color or brightness level, the user can accomplish this by invoking CELLTOP^{SM} Menu 1122, the availability of which is determined by the presence of CELLTOP^{SM} Menu Indicator 1112. In a preferred embodiment, the user invokes CELLTOP^{SM} Menu 1122 by pressing the right soft key on the wireless device. CELLTOP^{SM} Menu 1122 then “pops up” on the display screen and offers the user a variety of configuration options, including Set Color menu item 1124. The user then selects the Set Color menu item, preferably by pressing the arrows on the navigation keypad until the Set Color menu item is highlighted, and then directs the wireless device to perform the Set Color operation, preferably by pressing “OK” or “Enter” on the device keypad. Once the Set Color menu item is selected and invoked, Set Color Task Panel 1132 slides up from the bottom of the display screen. In a preferred embodiment, Set Color Task Panel 1132 comprises a continuum of available background color shades 1138 and Color Selector 1136. In this embodiment, the continuum of available background color shades shows blue at the far left, and moving to the right fades first to green, then to yellow, then to orange, and finally to red at the far right. Once Set Color Task Panel 1132 is displayed, the user modifies the background color by manipulating Color Selector 1136, preferably by using the left and right navigation keys, until the desired background color is indicated on Set Color Task Panel 1132. The user may also modify the brightness of the display by manipulating Brightness Selector 1134, preferably by using the up and down navigation keys, until the desired brightness is achieved. In a preferred embodiment, both the background color and the brightness of the display is automatically updated as the user manipulates the Color Selector or the Brightness Selector. Other embodiments would require the user to indicate that color or brightness selection is complete before updating the display.

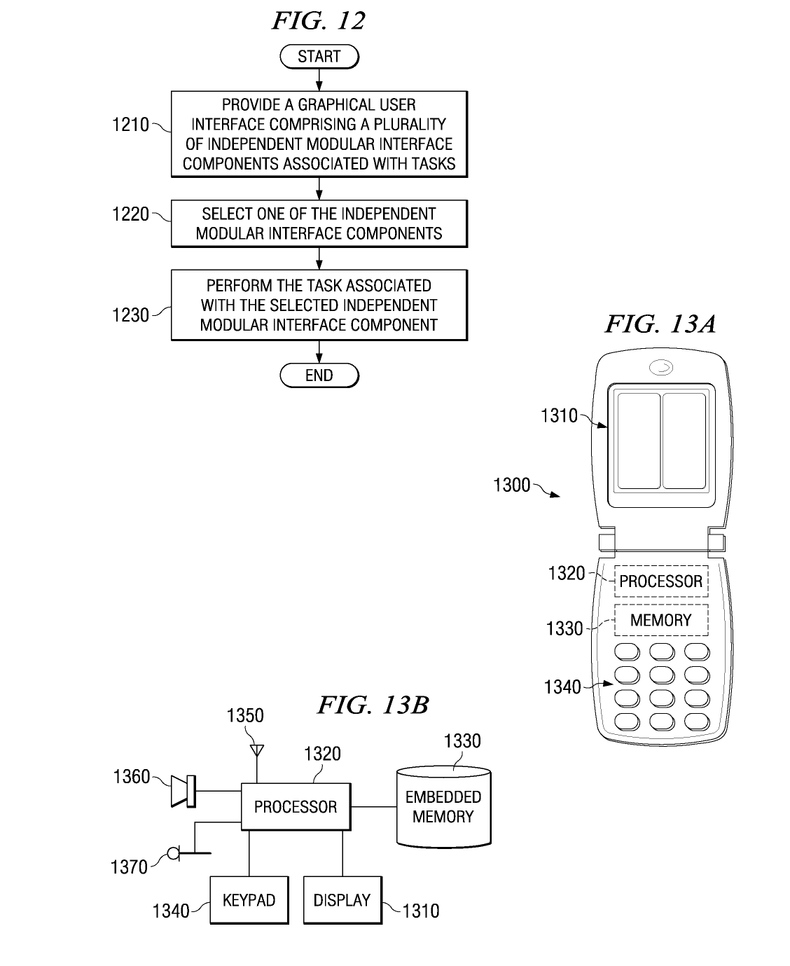

FIG. 12 is a process flow diagram depicting a representative process for performing a task with a wireless device employing a graphical user interface. First, the wireless device provides 1210 a graphical user interface. This graphical user interface is displayed on the device and comprises a plurality of independent modular interface components, or Cells. Each Cell is associated with a task. The user of the wireless device then directs the device to select 1220 a Cell representing the desired task. After the Cell is selected, the wireless device performs 1230 the task associated with the selected Cell. In preferred embodiments of the disclosed process, the graphical user interface, the Cells, and the tasks referred to in the process are as described throughout this specification.

FIG. 13 is a diagram illustrating a representative memory, processor, input, and output configuration suitable for performing a task with a wireless device employing a graphical user interface. FIG. 13A illustrates the components as built into a wireless device. FIG. 13B is a block diagram of the system. In this representative embodiment, wireless device 1300 comprises output device 1310 located on the wireless device. Output device 1310 is capable of displaying a graphical user interface as described throughout this specification. In a preferred embodiment, the output device is a visual display screen. Wireless device 1300 further comprises processor 1320 located within the external housing of the wireless device. Processor 1320 is in communication with output device 1310 and is configured to provide electronic signals associated with the graphical user interface to the output device. Wireless device 1300 further comprises memory 1330 located within the external housing of the wireless device. Memory 1330 is in communication with processor 1320 and is configured to store information associated with the graphical user interface. Wireless device 1300 further comprises input device 1340 located on the wireless device and in communication with the processor. Input device 1340 is capable of receiving input from the user as the user responds to cues from the graphical user interface as described throughout this specification. In a preferred embodiment, the input device is a keypad. Other input devices, such as navigation keys and soft keys can be incorporated into the keypad.

While various embodiments of a method and system for performing native and non-native tasks with a wireless device employing a graphical user interface have been described above, it should be understood that they have been presented by way of example only, and not limitation. Thus, the breadth and scope of the invention should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

We claim:

1. A method for performing one of a plurality of tasks with a wireless device, the method comprising:
providing a graphical user interface comprising a plurality of independent modular interface components, wherein the graphical user interface is user-configurable, and wherein each of the plurality of independent modular interface components is associated with one of the plurality of tasks;
selecting one of the plurality of independent modular interface components; and
performing the one of the plurality of tasks associated with the selected one of the plurality of independent modular interface components.

2. A method according to claim 1, wherein the plurality of tasks comprises:
a first task performed through an application native to the wireless device; and
a second task performed through an application developed for execution on a device-independent software platform.

3. A method according to claim 2, wherein the first task comprises initiating a telephone call.

4. A method according to claim 2, wherein the first task comprises sending a text message.

5. A method according to claim 2, wherein the device-independent software platform is QUALCOMM's Binary Runtime Environment for Wireless™ (BREW™).

6. A method according to claim 2, wherein the second task comprises retrieving electronic information and providing the retrieved electronic information through the wireless device.

7. A method according to claim 6, wherein the electronic information is retrieved from the World Wide Web.

8. A method according to claim 1, wherein the selecting one of the plurality of independent modular interface components comprises:
presenting one of an ordered series of visual display segments associated with the graphical user interface, wherein each of the visual display segments is adjacent to at least one other of the visual display segments, and wherein each of the visual display segments comprises at least one of the plurality of independent modular interface components;
performing at least one transition, wherein the transition comprises presenting an adjacent visual display segment, until a desired independent modular interface component is displayed; and
highlighting the desired independent modular interface component.

9. A method according to claim 8, wherein the ordered series of visual display segments is arranged horizontally.

10. A method according to claim 8, wherein the arrangement of the at least one of the plurality of independent modular interface components within each of the visual display segments in the series is defined by a visual display template selected from the group consisting of:
a first visual display template comprising a single zone, wherein one independent modular interface component appears in the single zone; and
a second visual display template comprising multiple zones, wherein one independent modular interface component appears in at least one of the multiple zones.

11. A method according to claim 10, wherein the second visual display template is selected from the group consisting of:
a two-zone visual display template comprising two zones, wherein each of the two zones encompasses substantially one-half of the visual display, and wherein one independent modular interface component appears in at least one of the two zones;
a four-zone visual display template comprising four zones, wherein each of the four zones encompasses substantially one-fourth of the visual display, and wherein one independent modular interface component appears in at least one of the four zones; and
a three-zone visual display template comprising three zones, wherein one of the three zones encompasses substantially one-half of the visual display, wherein two of the three zones encompasses substantially one-fourth of the visual display, and wherein one independent modular interface component appears in at least one of the three zones.

12. A graphical user interface for facilitating the performance of a plurality of tasks with a wireless device, the graphical user interface comprising:
an ordered series of visual display segments, wherein each of the visual display segments is adjacent to at least one other of the visual display segments, wherein each of the visual display segments comprises at least one of a plurality of independent modular interface components, wherein each of the plurality of independent modular interface components is associated with one of the plurality of tasks, and wherein a user can transition between adjacent visual display segments until a desired independent modular interface component is displayed.

13. The graphical user interface of claim 12, wherein the ordered series of visual display segments is arranged horizontally.

14. The graphical user interface of claim 12, wherein the plurality of tasks comprises:
a first task performed through an application native to the wireless device; and
a second task performed through an application developed for execution on a device-independent software platform.

15. The graphical user interface of claim 14, wherein the device-independent software platform is QUALCOMM's Binary Runtime Environment for Wireless™ (BREW™).

16. The graphical user interface of claim 12, further comprising:
a configuration menu through which the user can customize the graphical user interface.

17. The graphical user interface of claim 16, wherein the configuration menu comprises a menu item, and wherein the menu item enables the user to add a new independent modular interface component to the ordered series of visual display segments.

18. The graphical user interface of claim 17, wherein the new independent modular interface component is obtained from a local repository on the wireless device.

19. The graphical user interface of claim 17, wherein the new independent modular interface component is obtained from a source external to the wireless device through a wireless connection.

20. The graphical user interface of claim 19, wherein the new independent modular interface component is purchased from a source located on the World Wide Web through a wireless connection to the Internet.

21. The graphical user interface of claim 16, wherein the configuration menu comprises a menu item, and wherein the menu item enables the user to remove one of the plurality of independent modular interface components from the ordered series of visual display segments.

22. The graphical user interface of claim 16, wherein the configuration menu comprises a menu item, and wherein the menu item enables the user to move one of the plurality of independent modular interface components to a new location in the ordered series of visual display segments.

23. The graphical user interface of claim 22, further comprising:
a task panel representing the ordered series of visual display segments, wherein the user can select the new location for the one of the plurality of independent modular interface components by highlighting the desired new location represented in the task panel.

24. The graphical user interface of claim 16, further comprising:
a background theme for the graphical user interface, wherein the configuration menu comprises a menu item, and wherein the menu item enables the user to modify the background theme of the graphical user interface.

25. The graphical user interface of claim 24, further comprising:
a task panel representing available background themes, wherein the user can select a desired background theme for the graphical user interface by highlighting the desired background theme represented in the task panel.

26. The graphical user interface of claim 25, wherein the task panel representing available background themes comprises a continuum of background color shades, and wherein the highlighting the desired background theme comprises moving an indicator to a desired location along the continuum of background color shades.

27. The graphical user interface of claim 25, wherein the task panel representing available background themes comprises a background brightness level, and wherein the highlighting the desired background theme comprises adjusting an indicator until a desired background brightness level is achieved.

28. A graphical user interface for facilitating the performance of a plurality of tasks with a wireless device, the graphical user interface comprising:
an ordered series of visual display segments, wherein each of the visual display segments is adjacent to at least one of the other visual display segments, wherein each of the visual display segments comprises at least one of a plurality of independent modular interface components, and wherein each of the plurality of independent modular interface components is associated with one of the plurality of tasks;
a first popup configuration menu, wherein the first popup configuration menu is associated with the ordered series of visual display segments, the first popup configuration menu comprising:
a first menu item that enables a user to add an independent modular interface component to the ordered series of visual display segments; and
a second menu item that enables a user to modify the background theme of the graphical user interface; and
a plurality of second popup configuration menus, wherein each of the plurality of second popup configuration menus is associated with one of the plurality of independent modular interface components, each of the plurality of second popup configuration menus comprising:
a third menu item that enables a user to remove the associated one of the plurality of independent modular interface components from the ordered series of visual display segments; and
a fourth menu item that enables a user to move the associated one of the plurality of independent modular interface components to a new location in the ordered series of visual display segments.

29. A task panel displayed on a wireless device display screen, the task panel for enabling a user to move one of a plurality of independent modular interface components from a current location within an ordered series of visual display segments to a desired location within an ordered series of visual display segments, the task panel comprising:
a graphical representation of the ordered series of visual display segments; and
an indicator highlighting the current location of the one of the plurality of independent modular interface components within the ordered series of visual display segments, wherein the user can move the indicator within the graphical representation of the ordered series of visual display segments until the indicator highlights the desired location within the ordered series of visual display segments.

30. The task panel of claim 29, wherein the task panel is hidden until invoked.

31. The task panel of claim 30, wherein once invoked, the task panel slides up from the bottom of the wireless device display screen.

32. A task panel displayed on a wireless device display screen, the task panel for enabling a user to modify the appearance of a graphical user interface from a current background theme to a desired background theme, the task panel comprising:
a graphical representation of available background themes; and
an indicator highlighting the current background theme, wherein the user can move the indicator within the graphical representation of available background themes until the indicator highlights the desired background theme.

33. The task panel of claim 32, wherein the task panel is hidden until invoked.

34. The task panel of claim 33, wherein once invoked, the task panel slides up from the bottom of the wireless device display screen.

35. A system for performing a plurality of tasks with a wireless device, the system comprising:
an output device located on the wireless device, wherein the output device is capable of displaying a graphical user interface, wherein the graphical user interface is user configurable, wherein the graphical user interface comprises a plurality of independent modular interface components, and wherein each of the plurality of independent modular interface components is associated with one of the plurality of tasks;
a processor located within the wireless device in communication with the output device, wherein the processor is configured to provide electronic signals associated with the graphical user interface to the output device;
memory located within the wireless device in communication with the processor, wherein the memory is configured to store information associated with the graphical user interface; and
an input device located on the wireless device in communication with the processor, wherein a user can provide input to the processor through the input device in response to cues from the graphical user interface displayed on the output device.

36. The system of claim 35, wherein the plurality of tasks comprises:
a first task performed through an application native to the wireless device; and
a second task performed through an application developed for execution on a device-independent software platform.

37. The system of claim 36, wherein the first task comprises initiating a telephone call.

38. The system of claim 36, wherein the first task comprises sending a text message.

39. The system of claim 36, wherein the device-independent software platform is QUALCOMM's Binary Runtime Environment for Wireless™ (BREW™).

40. The system of claim 36, wherein the second task comprises retrieving electronic information and providing the retrieved electronic information through the wireless device.

41. The system of claim 40, wherein the electronic information is retrieved from the World Wide Web.

42. The system of claim 35, wherein the graphical user interface further comprises:
an ordered series of visual display segments, wherein each of the visual display segments is adjacent to at least one other of the visual display segments, wherein each of the visual display segments comprises at least one of the plurality of independent modular interface components, and wherein a user can transition between adjacent visual display segments until a desired independent modular interface component is displayed.

43. The system of claim 42, wherein the ordered series of visual display segments is arranged horizontally.
